(19) United States
(12) Patent Application Publication
(10) Pub. No.: US 2018/0361592 A1
(43) Pub. Date: Dec. 20, 2018

(54) CONTROL DEVICE AND ROBOT SYSTEM

(71) Applicant: Seiko Epson Corporation, Tokyo (JP)

(72) Inventor: Masaki MOTOYOSHI, Azumino (JP)

(21) Appl. No.: 16/009,324

(22) Filed: Jun. 15, 2018

(30) Foreign Application Priority Data
Jun. 16, 2017 (JP) 2017-118375

(51) Int. Cl. B25J 9/16; B25J 9/00; B25J 17/02

(52) U.S. Cl. CPC B25J 9/1697; B25J 17/0275; B25J 9/0087

(57) ABSTRACT

A control device comprising a processor controls a robot including a first arm driven via a first reduction gear by a first motor, wherein the processor receives a signal for instructing first processing for deriving parameters for improving position accuracy of the first arm and controls the first motor and cause the first arm to perform a first specific operation, wherein the first specific operation includes a first operation element for moving the first arm from a first position to a second position and a second operation element for moving the first arm in an opposite direction of a direction of the first operation element.

### BACKGROUND

### 1. Technical Field

The present invention relates to a technique for improving operation accuracy in a robot.

### 2. Related Art

In the robot technology field, a wave reduction gear is used as a reduction gear. The wave reduction gear includes an angle transmission error in principle. JP-A-2008-90692 (Patent Literature 1) proposes a control method for reducing the angle transmission error of the wave reduction gear. In the technique disclosed in Patent Literature 1, an integrated device of a motor and a reduction gear is assumed as a control target. When such a device is set as the control target, an angle transmission error of the device can be reduced by the following method. That is, measurement of an input and an output of the device is simultaneously performed after completion of the device to calculate a transmission error. A correction value for the device is determined on the basis of the transmission error. The device is controlled using the correction value.

However, in a device in which a plurality of sets of motors and reduction gears are used as in a robot, after the device is completed and set in a factory or the like, a part of the reduction gears is sometimes replaced in maintenance. In such a case, even if the device is controlled using a correction value set after the completion of the device, an angle transmission error of the entire device cannot be reduced.

In such a device, when a part of the reduction gears is replaced, a new correction value for the device can be determined by performing measurement of an input and an output of the device anew after the replacement. However, depending on an environment in which the device is set, a supplying device that supplies a member to be processed by the device, a conveying device that conveys the member processed by the device including the reduction gears to the next process, other machining devices, and the like are sometimes provided around the device including the reduction gears. In such a case, the measurement for determining a new correction value for the reduction gears has to be performed not to interfere with the devices around the device. Then, because an operation range of the device in the measurement decreases, the correction value sometimes cannot be determined with sufficient accuracy.

To sufficiently secure the operation range of the device in the measurement, the measurement for determining a new correction value for the reduction gears can also be performed after moving the device including the reduction gears to an environment in which no interfering object is present. However, in such a case, a time of suspension of production performed by the device increases compared with when the movement of the device is not performed.

As a technique for solving such a problem, JP-A-2011-212823 (Patent Literature 2) proposes a technique for calculating, from a torque command, a motor angle, and a fingertip position, correction values of angle transmission errors in joints of a robot rather than a correction value of an angle transmission error in the entire robot. In the technique proposed by Patent Literature 2, to determine correction parameters, measurement is performed by causing the robot to perform a linear operation in one direction on a horizontal plane.

However, Patent Literature 2 does not consider an operation that can improve measurement accuracy of the correction values when measuring the angle transmission errors. For example, in the linear operation on the horizontal plane carried out in Patent Literature 2, joints other than a joint in which a reduction gear for which a correction value is about to be determined is provided are simultaneously driven. Therefore, a measurement value includes an error due to the other joints. In the technique disclosed in Patent Literature 2, the measurement is performed by moving the joints in one direction. Therefore, in the technique disclosed in Patent Literature 2, a lost motion (an error of positions asymmetrical with respect to a direction of an operation due to a static friction force and elastic torsion of a shaft) and a backlash (an error of positions due to a gap between components that transmit a driving force) of the reduction gears are not considered.

### SUMMARY

An advantage of some aspects of the invention is to solve at least a part of the problems described above, and the invention can be implemented as the following forms or application examples.

(1) According to an aspect of the present disclosure, a control device that controls a robot is provided. The robot includes a first movable section driven via a first transmitting section by a first driving section configured to generate a driving force. The control device includes: a receiving section configured to receive a signal for instructing first processing for deriving parameters for improving position accuracy of the first movable section; and a control section configured to, because of the reception of the signal by the receiving section, control the first driving section and cause the first movable section to perform a first specific operation. The first specific operation includes a first operation element for moving the first movable section from a first position to a second position and a second operation element for moving the first movable section in an opposite direction of a direction of the first operation element. When the first operation element and the second operation element are executed, the control section detects, using a first input-position detecting section configured to detect an operating position on an input side of the first transmitting section, the operating position on the input side of the first transmitting section and detects, using a first output-position detecting section configured to detect an operating position on an output side of the first transmitting section, the operating position on the output side of the first transmitting section.

With such a form, it is possible to detect the operating position on the input side and the operating position on the output side of the first transmitting section when the first operation element is executed. It is possible to detect the operating position on the input side and the operating position on the output side of the first transmitting section when the second operation element in the opposite direction of the direction of the first operation element is executed. Therefore, it is possible to acquire, concerning the two movements in the opposite directions, deviation between an ideal operating position on the output side theoretically calculated from the operating position on the input side and a measured operating position on the output side. Therefore, it is possible to determine, on the basis of measurement values of the deviation in the two movements, considering a lost motion and a backlash, parameters for improving position accuracy of the first movable section.

(2) In the control device according to the aspect, the first operation element and the second operation element may be rotations, the operating position on the input side of the first transmitting section may be an angular position, and the operating position on the output side of the first transmitting section may be an angular position. According to such an aspect, it is possible to highly accurately determine a correction value for eliminating an angle transmission error of the first transmitting section that transmits a rotational motion.

(3) In the control device according to the aspect, both of moving speeds of the first operation element and the second operation element may be 100°/second or less. With such a form, it is possible to reduce the influence of vibration or the like due to inertia of the first movable section on the operating positions on the output side and the input side of the first transmitting section compared with a form in which the moving speeds of the first operation element and the second operation element are larger than 100°/second and perform the measurement.

(4) In the control device according to the aspect, the first transmitting section may cause a cyclic transmission error with respect to a continuous constant input from the first driving section, and an angular range between the first position and the second position may include an angular range in which the transmission error for one cycle is caused. With such a form, it is possible to measure an angle transmission error of the first transmitting section with higher accuracy compared with a form in which the angular range between the first position and the second position is smaller than the angular range in which the transmission error for one cycle is caused.

(5) In the control device according to the aspect, the first transmitting section may include a reduction gear configured to convert a rotary input into a rotary output having a rotational speed lower than a rotational speed of the rotary input.

(6) In the control device according to the aspect, the first output-position detecting section may detect an operating position of an output shaft of the first transmitting section. With such a form, it is possible to accurately detect an output position of the first transmitting section compared with a form in which an operating position of a downstream component driven by an output of the first transmitting section is measured.

(7) In the control device according to the aspect, the first output-position detecting section may be an inertial sensor that can detect at least one of angular velocity and acceleration of the first movable section. With such a form, when the inertial sensor for detecting the angular velocity of the first movable section is provided in the first movable section, it is possible to detect an output position of the first transmitting section effectively utilizing the inertial sensor.

(8) In the control device according to the aspect, the parameters may include a correction value for reducing a transmission error of the first transmitting section. With such a form, it is possible to determine, on the basis of measurement values obtained when the first operation element and the second operation element are executed, considering a lost motion and a backlash, a correction value for reducing the transmission error of the first transmitting section.

(9) In the control device according to the aspect, the parameters may include a parameter for deriving a correction value for reducing a transmission error of the first transmitting section. With such a form, it is possible to determine, on the basis of measurement values obtained when the first operation element and the second operation element are executed, considering a lost motion and a backlash, a parameter for reducing the transmission error of the first transmitting section.

(10) In the control device according to the aspect, the second operation element may be an operation for moving the first movable section from the second position to the first position. With such a form, it is possible to determine, concerning the two movements in the opposite directions, at the same degree of accuracy, parameter for improving the position accuracy of the first movable section.

(11) In the control device according to the aspect, the first specific operation may include a plurality of combinations of the first operation element and the second operation element. With such a form, it is possible to more highly accurately determine, concerning the two movements in the opposite directions, parameters for improving position accuracy of the first movable section compared with a form in which a combination of the first operation element and the second operation element is performed only once as the first specific operation.

(12) In the control device according to the aspect, the receiving section may receive, as the signal for instructing the first processing, a signal representing a command to the effect that the first processing should be executed. With such a form, a user can designate, in detail, content desired by the user using the command and cause the control device to detect an operating position on the input side and an operating position on the output side of a reduction gear of a joint.

(13) In the control device according to the aspect, the robot may include two or more movable sections driven in joints via transmitting sections by driving sections configured to respectively generate driving forces, and the signal for instructing the first processing may include information representing designation of the joint of one movable section functioning as the first movable section among the two or more movable sections. With such a form, it is possible to perform, reflecting an intention of the user, the first processing concerning a movable section corresponding to the designated joint and detect the operating position on the input side and the operating position on the output side of the first transmitting section.

(14) The control device according to the aspect, the robot may further include a second movable section driven via a second transmitting section by a second driving section configured to generate a driving force, the receiving section may receive a signal for instructing second processing for deriving the parameters for improving position accuracy of the first movable section and deriving parameters for improving position accuracy of the second movable section, because of the reception of the signal for instructing the second processing by the receiving section, the control device may control the first driving section and cause the first movable section to perform the first specific operation and control the second driving section and cause the second movable section to perform a second specific operation in parallel to at least a part of the first specific operation, the second specific operation may include a third operation element for moving the second movable section from a third position to a fourth position and a fourth operation element for moving the second movable section in an opposite direction of a direction of the third operation element, the control section may detect the operating position on the input side of the first transmitting section using the first input-position detecting section and detect the operating position on the output side of the first transmitting section using the first output-position detecting section when the first operation element and the second operation element are executed and detect, using a second input-position detecting section configured to detect an operating position on the input side of the second transmitting section, the operating position on the input side of the second transmitting section and detect, using a second output-position detecting section configured to detect an operating position on the output side of the second transmitting section, the operating posit ion on the output side of the second transmitting section when the third operation element and the fourth operation element are executed.

With such a form, it is possible to determine, in a short time, parameters for improving position accuracy of the first movable section and the second movable section compared with a form in which measurement concerning the first transmitting section and measurement concerning the second transmitting section are performed one after another.

(15) In the control device according to the aspect, the first operation element to the fourth operation element may be rotations, all of the operating position on the input side of the first transmitting section, the operating position on the output side of the first transmitting section, the operating position on the input side of the second transmitting section, and the operating position on the output side of the second transmitting section may be angular positions, and a rotation axis of the first movable section and a rotation axis of the second movable section are perpendicular to each other. With such a form, it is possible to obtain measurement results by the first specific operation and the second specific operation without the first specific operation and the second specific operation affecting each other.

(16) In the control device according to the aspect, the robot may include three or more movable sections driven in joints via transmitting sections by driving sections configured to generate driving forces, and the signal for instructing the second processing may include information representing designation of the joint of one movable section functioning as the first movable section and designation of the joint of another one movable section functioning as the second movable section among the three or more movable sections. With such a form, the user can easily perform an instruction to the effect that the second processing should be performed on the two movable sections to detect operating positions on the input side and operating positions on the output side of the transmitting sections of the movable sections.

(17) According to another aspect of the present disclosure, a robot controlled by the control device according to any one of the aspects explained above is provided.

(18) According to another aspect of the present disclosure, a robot system including: the control device according to any one of the aspects explained above; and the robot controlled by the control device is provided.

Not all of the plurality of components in the aspects of the present disclosure explained above are essential. To solve a part or all of the problems described above or achieve a part or all of the effects described in this specification, it is possible to perform a change, deletion, replacement with new other components, and partial deletion of limitation content concerning a part of the plurality of components. To solve a part or all of the problems described above or achieve a part or all of the effects described in this specification, it is also possible to combine a part or all of the technical features included in one aspect of the present disclosure described above with a part or all of the technical features included in the other aspects of the present disclosure to form an independent aspect of the present disclosure.

### BRIEF DESCRIPTION OF THE DRAWINGS

The invention will be described with reference to the accompanying drawings, wherein like numbers reference like elements.

FIG. 1 is an explanatory diagram showing a robot system according to a first embodiment.

FIG. 2 is a block diagram showing a relation between components of a control section of a robot control device and a servomotor, a motor angle sensor, a reduction gear, and an output-side angle sensor included in a robot.

FIG. 3A shows an angular position of an input shaft of the reduction gear at the time when an output shaft of the servomotor rotates at a constant speed.

FIG. 3B shows an example of an angular position of an output shaft of the reduction gear at the time when the constant speed is continuously input from the output shaft of the servomotor.

FIG. 4A shows an example of an angular position of the input shaft of the reduction gear at the time when a constant speed is about to be continuously output from the output shaft of the reduction gear.

FIG. 4B shows an angular position of the output shaft of the reduction gear at the time when the constant speed is about to be continuously output from the output shaft of the reduction gear.

FIG. 5 is a flowchart for explaining a procedure of setting for deriving parameters for improving position accuracy of an arm.

FIG. 6 is a graph showing an error of an angular position at the time when the arm is moved in a certain direction.

FIG. 7 is an explanatory diagram showing a robot according to a second embodiment.

FIG. 8 is a diagram showing a user interface displayed on a display of a setting device in step S100 in FIG. 5 in the second embodiment.

FIG. 9 is a diagram showing a user interface displayed on the display of the setting device when step S200 in FIG. 5 is executed.

FIG. 10 is a diagram showing a correction value table stored in a ROM in step S400 in FIG. 5.

FIG. 11 is a diagram showing a user interface displayed on the display of the setting device in step S100 in FIG. 5 in a third embodiment.

FIG. 12 is a diagram showing a command and attached parameters for causing a joint to perform a specific operation in an angular range of 10° in step S200 in FIG. 5.

FIG. 13 is a diagram showing a plurality of commands and a plurality of attached parameters for causing joints to respectively perform specific operations in the angular range of 10° in step S200 in FIG. 5.

### DESCRIPTION OF EXEMPLARY EMBODIMENTS

### A. First Embodiment

### A1. Configuration of a Robot System

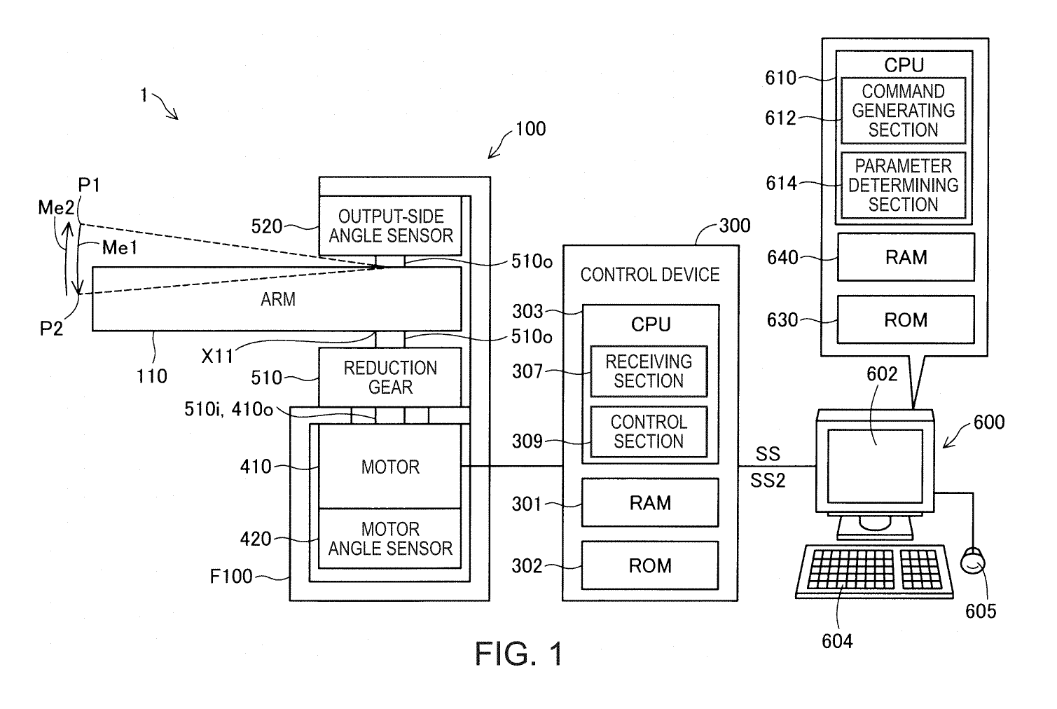

FIG. 1 is an explanatory diagram showing a robot system 1 according to a first embodiment. The robot system 1 according to this embodiment includes a robot 100, a robot control device 300, and a setting device 600.

The robot 100 is a one-axis robot including an arm 110 including a rotary joint X11. The joint X11 is a torsion joint. The robot 100 can dispose the arm 110 in a designated position in a three-dimensional space by rotating the joint X11. Note that, in the first embodiment, to facilitate understanding of a technique, a robot including only one rotary joint X11 is explained as an example. However, the present disclosure is applicable to a multi-axis robot including a plurality of joints.

The robot 100 further includes a servomotor 410, a reduction gear 510, a motor angle sensor 420, an output-side angle sensor 520, and a frame F100. The arm 110, the servomotor 410, the reduction gear 510, the motor angle sensor 420, and the output-side angle sensor 520 are attached to the frame F100.

The servomotor 410 is supplied with an electric current from the robot control device 300 to generate a driving force. More specifically, the servomotor 410 is supplied with the electric current to rotate an output shaft 410o of the servomotor 410. The motor angle sensor 420 detects an angular position of the output shaft 410o. The angular position of the output shaft 410o detected by the motor angle sensor 420 is transmitted to the robot control device 300.

The reduction gear 510 includes an input shaft 510i and an output shaft 510o. The reduction gear 510 converts a rotary input to the input shaft 510i into a rotary output having a rotational speed lower than the rotational speed of the rotary input and outputs the rotary output from the output shaft 510o. The reduction gear 510 is specifically a wave reduction gear.

The input shaft 510i of the reduction gear 510 is connected to the output shaft 410o of the servomotor 410. An angular position of the input shaft 510i is equal to the angular position of the output shaft 410o of the servomotor 410. Therefore, the motor angle sensor 420, which can detect the angular position of the output shaft 410o of the servomotor 410, detects the angular position of the input shaft 510i of the reduction gear 510.

The reduction gear 510 causes a cyclic transmission error with respect to a continuous constant input from the output shaft 410o of the servomotor 410. That is, the rotational speed and the angular position of the output shaft 510o of the reduction gear 510 includes cyclic deviation with respect to a continuous rotary input of a constant speed from the output shaft 410o of the servomotor 410.

The arm 110 is fixed to the output shaft 510o of the reduction gear 510. As a result, the arm 110 is rotated in the joint X11 via the reduction gear 510 according to the rotation of the output shaft 510o.

The output-side angle sensor 520 is disposed on the opposite side of the reduction gear 510 across the arm 110. The output shaft 510o of the reduction gear 510 pierces through the arm 110. The output-side angle sensor 520 detects an angular position of the output shaft 510o of the reduction gear 510. That is, whereas the motor angle sensor 420 detects an operating position on an input side of the reduction gear 510, the output-side angle sensor 520 detects an operating position on an output side of the reduction gear 510.

Note that, in this specification, in a transmitting section (in this embodiment, the reduction gear 510) that transmits a driving force, an operating position of a member (in this embodiment, the input shaft 510i) that receives an input driving force is described as “operating position on the input side”. In the transmitting section that transits a driving force, an operating position of a member (in this embodiment, the output shaft 510o) that transmits an output driving force to another component is described as “operating position on the output side”.

The output-side angle sensor 520 is specifically an optical rotary encoder. However, the output-side angle sensor 520 is an encoder that can detect an absolute angular position. By providing the rotary encoder that detects an angular position of the output shaft 510o of the reduction gear 510, it is possible to accurately detect an output position of the reduction gear 510 compared with a form in which an operating position of a more downward component (e.g., an end effector) driven by an output of the reduction gear 510 is measured. The angular position of the output shaft 510o detected by the output-side angle sensor 520 is transmitted to the robot control device 300.

The robot control device 300 is a control device that controls the robot 100. The robot control device 300 is connected to the robot 100. The robot control device 300 is a computer including a RAM 301, a ROM 302, and a CPU 303. The CPU 303 realizes various functions explained below by loading computer programs stored in the ROM 302 to the RAM 301 and executing the computer programs.

The setting device 600 sets, in the robot control device 300, parameters used in the operation of the robot 100. The setting device 600 is a computer including a display 602 functioning as an output device and a keyboard 604 and a mouse 605 functioning as an input device. The setting device 600 further includes a CPU 610, a ROM 630, and a RAM 640. The CPU 610 realizes various functions explained below by loading computer programs stored in the ROM 630 to the RAM 640 and executing the computer programs.

The setting device 600 is connected to the robot control device 300. The setting device 600 determines, on the basis of outputs from the robot control device 300 (specifically, the motor angle sensor 420, the output-side angle sensor 520, etc.), parameters used in the operation of the robot 100. The setting device 600 causes the ROM 302 of the robot control device 300 to store the parameters. The robot control device 300 generates, using the parameters, a control signal output to the robot 100. A functional section of the CPU 303 that generates a control signal on the basis of the parameters and controls the robot 100 is shown in FIG. 1 as a “control section 309”.

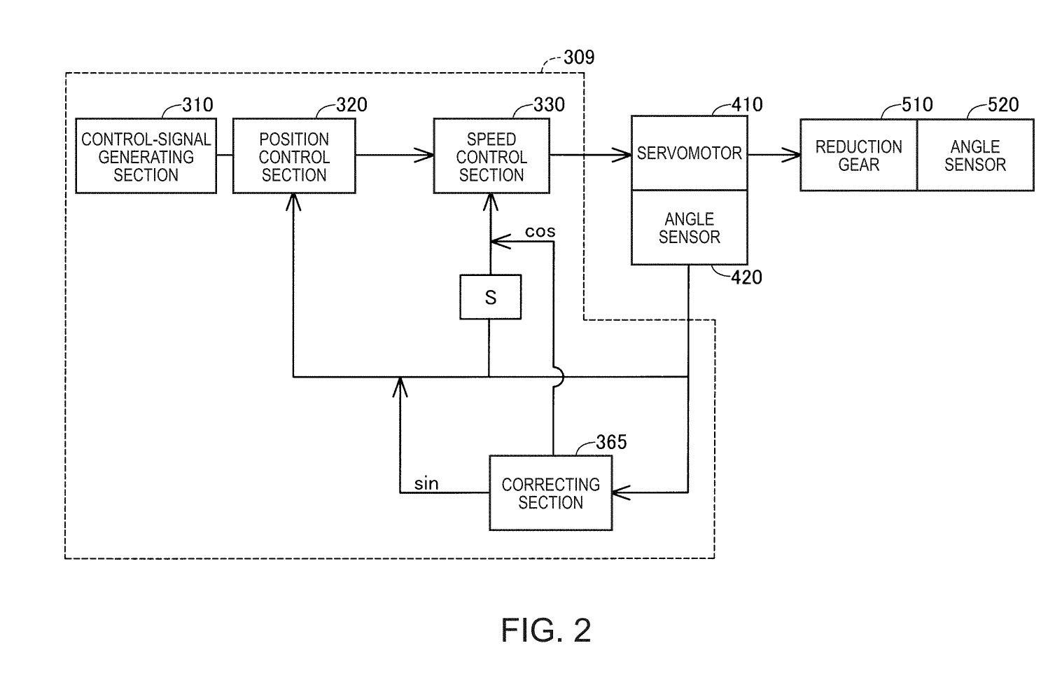

FIG. 2 is a block diagram showing a relation between components of the control section 309 of the robot control device 300 and the servomotor 410, the motor angle sensor 420, the reduction gear 510, and the output-side angle sensor 520 included in the robot 100. The control section 309 of the robot control device 300 includes a control-signal generating section 310, a position control section 320, a speed control section 330, and a correcting section 365.

The control-signal generating section 310 generates a position control signal representing a target position where the arm 110 should be located and outputs the position control signal to the position control section 320.

The position control section 320 receives a position control signal from the control-signal generating section 310. The position control section 320 receives, as a position feedback, an angular position of the servomotor 410 from the motor angle sensor 420 of the robot 100. The position control section 320 generates a speed control signal for the servomotor 410 of the robot 100 on the basis of information concerning the position control signal and the angular position and outputs the speed control signal to the speed control section 330.

The speed control section 330 receives the speed control signal from the position control section 320. The speed control section 330 receives, as a speed feedback, a signal obtained by differentiating the angular position of the servomotor 410 output from the motor angle sensor 420, that is, a signal of a rotational speed. In FIG. 2, a block representing the differential of the angular position is indicated by a block attached with “S”. The speed control section 330 generates a torque control signal on the basis of the speed control signal output from the position control section 320 and the rotational speed of the servomotor 410 and outputs the torque control signal. Thereafter, a current amount supplied to the servomotor 410 is determined on the basis of the torque control signal. An electric current having the determined current amount is supplied to the servomotor 410.

The correcting section 365 receives a signal of the angular position of the output shaft 410o (equal to the angular position of the input shaft 510i of the reduction gear 510) from the motor angle sensor 420. The correcting section 365 determines a direction of rotation of the servomotor 410 from a signal of the latest angular position of the output shaft 410o and a signal of the immediately preceding angular position and generates a correction signal according to the direction of the rotation and the latest angular position. The correcting section 365 outputs the correction signal to the position control section 320. As a result, the position control section 320 receives a signal obtained by adding up the angular position of the servomotor 410 output from the motor angle sensor 420 and the correction signal output from the correcting section 365.

Further, the correcting section 365 outputs a signal obtained by differentiating the correction signal to the speed control section 330. As a result, the speed control section 330 receives a signal obtained by adding up the speed signal obtained by differentiating the angular position of the servomotor 410 and the signal obtained by differentiating the correction signal output from the correcting section 365.

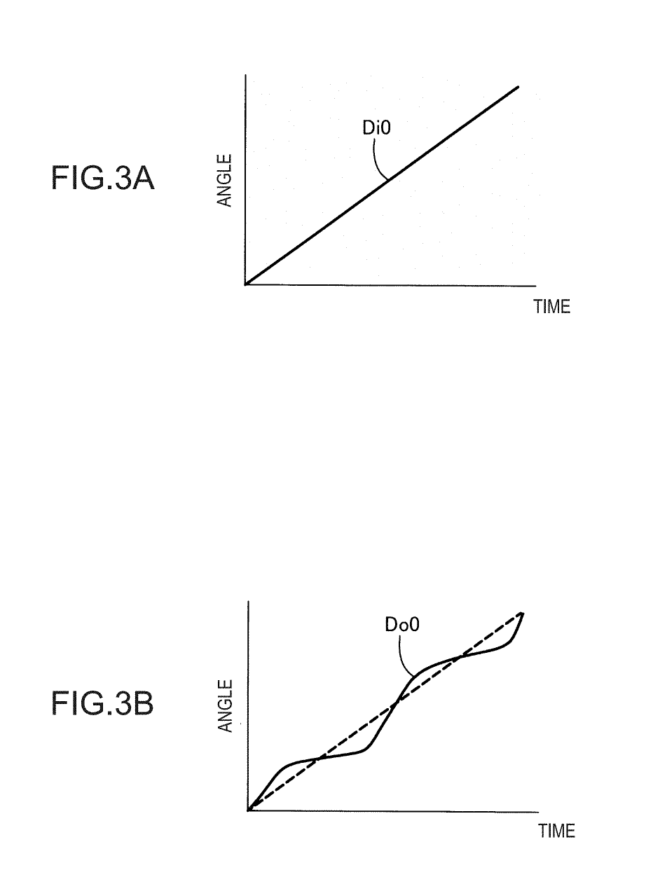

FIG. 3A shows an angular position Di0 of the output shaft 410o of the servomotor 410 (i.e., the input shaft 510i of the reduction gear 510) at the time when the output shaft 410o of the servomotor 410 rotates at a constant speed. FIG. 3B shows an example Do0 of an angular position of the output shaft 510o of the reduction gear 510 at the time when the constant speed is continuously input from the output shaft 410o of the servomotor 410. However, a scale of the angular position Do0 of the output shaft 510o shown in FIG. 3B and a scale of the angular position Di0 of the input shaft 510i shown in FIG. 3A are different. FIGS. 3A and 3B respectively show the angular position Di0 of the input shaft 510i and the angular position Do0 of the output shaft 510o at the time when it is assumed that the correcting section 365 does not output a correction value.

As explained above, the reduction gear 510 causes a cyclic transmission error with respect to the continuous input of the constant speed from the output shaft 410o of the servomotor 410. Therefore, whereas the angular position Di0 of the input shaft 510i of the reduction gear 510 increases in proportion to time, the angular position Do0 of the output shaft 510o of the reduction gear 510 includes cyclic deviation with respect to a proportional value (indicated by a broken line) with respect to the time.

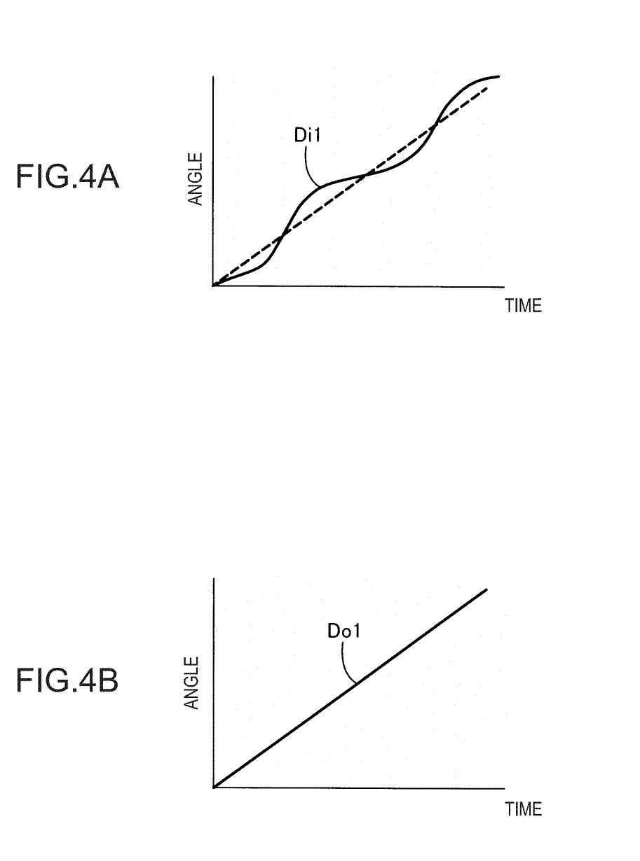

FIG. 4A shows an example Di1 of an angular position of the input shaft 510i of the reduction gear 510 at the time when a constant speed is about to be continuously output from the output shaft 510o of the reduction gear 510 in this embodiment. FIG. 4B shows an angular position Do1 of the output shaft 510o of the reduction gear 510 at the time when a constant speed is about to be continuously output from the output shaft 510o of the reduction gear 510 in this embodiment. However, a scale of the angular position Do1 of the output shaft 510o shown in FIG. 4B and a scale of the angular position Di1 of the input shaft 510i shown in FIG. 4A are different. FIGS. 4A and 4B show a desired angular position Di1 of the input shaft 510i and a desired angular position Do1 of the output shaft 510o at the time when the correcting section 365 is caused to function and the constant speed is about to be continuously output in the output shaft 510o of the reduction gear 510. Note that, for reference, the angular position Di1 of the input shaft 510i shown in FIG. 3A is indicated by a broken line in FIG. 4A.

As explained above, the position control section 320 receives, as a position feedback, the signal obtained by adding up the angular position of the servomotor 410 output from the motor angle sensor 420 and the correction signal output from the correcting section 365 (see FIG. 2). The speed control section 330 receives, as a speed feedback, the signal obtained by adding up the speed signal obtained by differentiating the angular position of the servomotor 410 and the signal obtained by differentiating the correction signal output from the correcting section 365. When the position control section 320 generates a speed control signal on the basis of such a position feedback and the speed control section 330 generates a torque control signal on the basis of such a speed feedback, the angular position of the output shaft 410o of the servomotor 410, that is, the angular position Di1 of the input shaft 510i of the reduction gear 510 has cyclic deviation with respect to a value proportional to time (see a broken line in FIG. 4A) as shown in FIG. 4A.

When an input for realizing the angular position Di1 shown in FIG. 4A is received for the input shaft 510i, the angular position Do1 of the output shaft 510o changes to a straight line proportional to time as shown in FIG. 4B. The correcting section 365 achieves, on the basis of such a principle, a function of improving accuracy of the angular position Do1 of the output shaft 510o (see FIG. 2).

When it is assumed that a cyclic correction signal that should be output from the correcting section 365 to the position control section 320 is a value obtained by multiplying a sine (sin) by a predetermined coefficient corresponding to a position, a differential value of a correction signal output from the correcting section 365 to the speed control section 330 is a value obtained by multiplying a cosine (cos) by a predetermined coefficient corresponding to speed (see FIG. 2). As the differential value of the correction signal, the value mathematically calculated by multiplying the cosine (cos) by the coefficient corresponding to the speed has a less temporal delay than a value calculated by a difference between a correction signal based on an angular position of the servomotor 410 in the immediately preceding time and a correction signal based on the latest angular position. Therefore, according to this embodiment, it is possible to perform accurate correction.

### A2. Setting of Parameters for Improving Position Accuracy

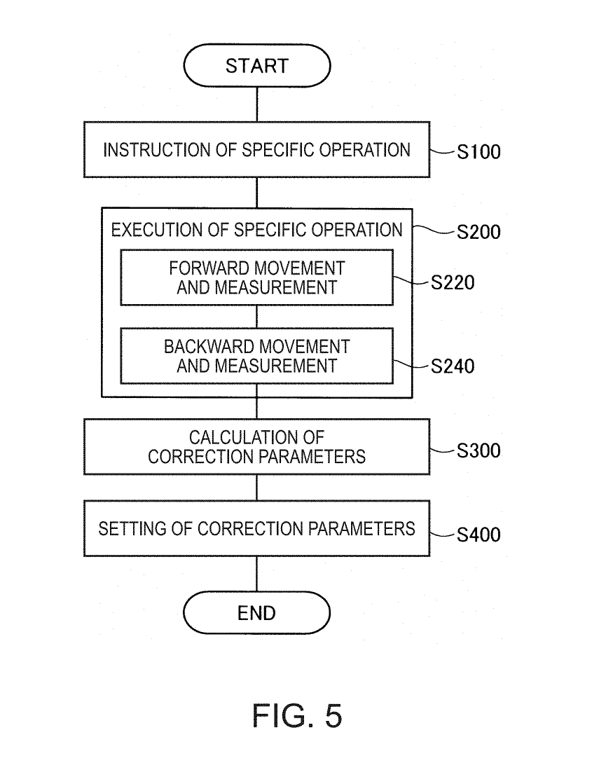

FIG. 5 is a flowchart for explaining a procedure of setting for deriving parameters for improving position accuracy of the arm 110. Processing shown in FIG. 5 is executed by the setting device 600, the robot control device 300, and the robot 100.

In step S100, a user instructs a start of processing for deriving parameters for improving position accuracy of the arm 110. Specifically, the user instructs a start time of the processing to the setting device 600 via the keyboard 604 and the mouse 605 (see FIG. 1). When the instruction is input to the setting device 600, the setting device 600 transmits, to the robot control device 300, a signal SS for instructing the processing for deriving parameters for improving position accuracy of the arm 110. A functional section of the CPU 610 of the setting device 600 that generates such a signal is shown as a “command generating section 612” in FIG. 1. A functional section that achieves a function of receiving the signal in the robot control device 300 is shown as a “receiving section 307” in FIG. 1.

In step S200 in FIG. 5, because the receiving section 307 receives the signal SS for instructing the processing for deriving parameters for improving position accuracy of the arm 110, the control section 309 of the robot control device 300 drives the servomotor 410 of the robot 100 and causes the arm 110 to perform a specific operation.

Specifically, in step S220, the control section 309 causes the arm 110 to rotate from a first position P1 (see FIG. 1), which is a predetermined angular position, to a second position P2, which is also a predetermined angular position. A moving speed at that time is 100°/second or less. In this specification, this operation is referred to as “first operation element Me1” or “forward movement”.

In this embodiment, an angular range between the first position P1 and the second position P2 is an angular range in which the reduction gear 510, which causes a cyclic transmission error, causes a change in a transmission error for one cycle and does not cause a change in a transmission error for four or more cycles. Because the reduction gear 510 is the wave reduction gear, every time the input shaft 510i makes a half rotation, an angle transmission error between the input shaft 510i and the output shaft 510o causes a change for one cycle. Therefore, the angular range between the first position P1 and the second position P2 is an angular range larger than a half cycle and smaller than two cycles in an angular range of the input shaft 510i.

While the first operation element Me1 is executed, the control section 309 of the robot control device 300 detects, using the motor angle sensor 420, an operating position on the input side of the reduction gear 510, that is, an angular position of the input shaft 510i (see FIG. 1). While the first operation element Me1 is executed, the control section 309 of the robot control device 300 detects, using the output-side angle sensor 520, an operating position on the output side of the reduction gear 510, that is, an angular position of the output shaft 510o. The detected respective angular positions are transmitted to the robot control device 300 and transmitted to the setting device 600 via the robot control device 300.

In step S240, the control section 309 causes the arm 110 to rotate from the second position P2 to the first position P1. That is, in this operation, the arm 110 moves in the opposite direction of the direction of the first operation element Me1. A moving speed in the operation is 100°/second or less. In this specification, this operation is referred to as “second operation element Me2” or “backward movement”.

By setting the moving speeds of the first operation element Me1 and the second operation element Me2 to the relatively small values described above, it is possible to reduce the influence of vibration due to the inertia of the arm 110 (including vibration during the movement of the arm 110 and residual vibration of the arm 110 after a stop instruction) on the operating positions on the output side and the input side of the reduction gear 510.

While the second operation element Me2 is executed, the control section 309 of the robot control device 300 detects, using the output-side angle sensor 520, an operating position on the input side of the reduction gear 510, that is, an angular position of the input shaft 510i. While the second operation element Me2 is executed, the control section 309 of the robot control device 300 detects, using the output-side angle sensor 520, an operating position on the output side of the reduction gear 510, that is, an angular position of the output shaft 510o. The detected respective angular positions are transmitted to the robot control device 300 and transmitted to the setting device 600 via the robot control device 300.

By performing such processing, it is possible to detect the operating position on the input side and the operating position on the output side of the reduction gear 510 at the time when the first operation element Me1 is executed (see S220 in FIG. 5). It is possible to detect the operating position on the input side and the operating position on the output side of the reduction gear 510 when the second operation element Me2 in the opposite direction of the direction of the first operation element Me1 is executed (see S240 in FIG. 5). Therefore, it is possible to acquire, concerning the two movements in the opposite directions, deviation between an ideal operating position on the output side theoretically calculated from the operating position on the input side and a measured operating position on the output side (see FIG. 3B). Therefore, the setting device 600 can determine, on the basis of measurement values of the deviation in the two movements, considering a lost motion and a backlash, parameters for improving position accuracy of the arm 110.

In step S200, the processing in steps S220 and S240 is repeatedly performed a plurality of times. That is, in step S200, a specific operation including a plurality of combinations of the first operation element Me1 and the second operation element Me2 is executed.

By performing such processing, parameters for highly accurate correction are obtained without causing the arm 110 to greatly move. Therefore, even when the reduction gear 510 of the robot 100 is replaced after the robot 100 is set in a factory, parameters for highly accurate correction are obtained without moving the robot 100 from a setting place of the robot 100 and without the robot 100 interfering with structures around the robot 100.

In step S300 in FIG. 5, the CPU 610 of the setting device 600 calculates values of correction parameters on the basis of measurement results of angular positions of the arm 110 in the respective operation elements obtained in step S220. More specifically, the CPU 610 of the setting device 600 calculates, concerning the respective operation elements, deviation between an ideal operating position on the output side theoretically calculated from the operating position on the input side and a measured operating position on the output side. The CPU 610 calculates a correction value such that the deviation concerning the respective operation elements can be cancelled. Such a functional section of the CPU 610 of the setting device 600 is shown as a parameter determining section 614 in FIG. 1.

First, the parameter determining section 614 obtains deviation of an actual angular position of the output shaft 510o with respect to an ideal angular position of the output shaft 510o obtained from the angular position of the input shaft 510i, that is, a change along the angular position of the input shaft 510i of an angle transmission error in the first operation element Me1. The parameter determining section 614 approximates the angle transmission error with a sine wave. An approximation formula of the angle transmission error is indicated by Expression (1).

α=A×sin(n×θ+ϕ) (1)

where, α represents an angle transmission error, θ represents an angular position of the input shaft 510i of the reduction gear 510, A represents amplitude (a first setting parameter), n represents a coefficient corresponding to a cycle of the angle transmission error, and ϕ represents a phase correction amount (a second setting parameter)

In the expression, n is the number of cycles of a change caused by, while an input shaft of a reduction gear rotates once, an angle transmission error between the input shaft and an output shaft. A value of n is determined by the configuration of the reduction gear 510. Because the reduction gear 510 is the wave reduction gear in this embodiment, every time the input shaft 510i makes a half rotation, an angle transmission error between the input shaft 510i and the output shaft 510o causes a change for one cycle. That is, in this embodiment, n is 2 and multiples of 2.

The parameter determining section 614 calculates the amplitude A and the phase correction amount ϕ of Expression (1) described above according to a multiple regression analysis on the basis of a plurality of sets of measurement results of the angular position of the arm 110 in the first operation element Me1 obtained in step S220. The amplitude A is referred to as “first correction parameter” as well. The phase correction amount ϕ is referred to as “second correction parameter” as well. The first correction parameter and the second correction parameter are parameters for deriving a correction value for reducing a transmission error of the reduction gear 510. The amplitude A and the phase correction amount ϕ corresponding to the first operation element Me1 are respectively represented as amplitude A1 and a phase correction amount ϕ1.

According to the same processing, the parameter determining section 614 calculates the amplitude A and the phase correction amount ϕ of Expression (1) described above on the basis of a plurality of sets of measurement results of the angular position of the arm 110 in the second operation element Me2 obtained in step S240. The amplitude A and the phase correction amount ϕ corresponding to the second operation element Me2 are respectively represented as amplitude A2 and a phase correction amount ϕ2.

In step S400 in FIG. 5, the parameter determining section 614 of the setting device 600 causes the ROM 302 of the robot control device 300 to store a combination of the amplitude A1 and the phase correction amount ϕ1 and a combination of the amplitude A2 and the phase correction amount ϕ2 respectively in association with a direction of the first operation element Me1 and a direction of the second operation element Me2. These parameters are displayed on the display 602 of the setting device 600.

In the operation of the robot 100, when the servomotor 410 is rotating in the same direction as the direction of the first operation element Me1, the correcting section 365 of the control section 309 calculates, as a correction parameter, the angle transmission error α corresponding to the angular position θ of the input shaft 510i of the reduction gear 510 on the basis of Expression (1) using the amplitude A1 and the phase correction amount ϕ1. The correcting section 365 adds a correction amount “−α” for cancelling the obtained angle transmission error α to a position feedback to the position control section 320 (see FIG. 2). The correcting section 365 adds a differential value of the correction amount “−α” to a speed feedback to the speed control section 330. By performing such processing, it is possible to determine an appropriate correction value with respect to any operating position on the input side.

When the servomotor 410 is rotating in the same direction as the direction of the second operation element Me2 (the opposite direction of the direction of the first operation element Me1), the correcting section 365 of the control section 309 calculates, as a correction parameter, the angle transmission error α corresponding to the angular position θ of the input shaft 510i of the reduction gear 510 on the basis of expression (1) using the amplitude A2 and the phase correction amount ϕ2. The correcting section 365 adds the correction amount “−α” for cancelling the obtained angle transmission error α to the position feedback to the position control section 320 (see FIG. 2). The correcting section 365 adds a differential value of the correction amount “α” to a speed feedback to the speed control section 330. By performing such processing, it is possible to determine an appropriate correction value with respect to any operating position on the input side.

By switching the processing according to the operation direction as explained above, it is possible to perform highly accurate correction of an angle transmission error for cancelling a lost motion and a backlash of a reduction gear (see FIGS. 3A to 4B).

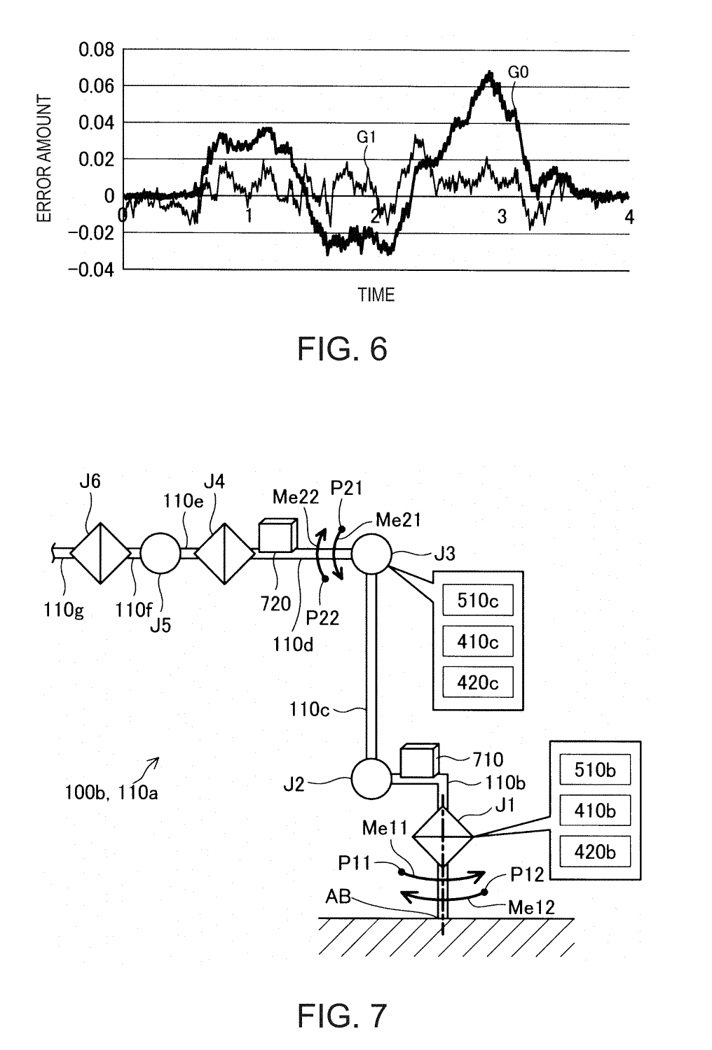

FIG. 6 is a graph showing an error of an angular position at the time when the arm 110 is moved in a certain direction. A graph G0 is a graph showing an error of an angular position at the time when the function of the correcting section 365 is stopped and the arm 110 is moved. A graph G1 is a graph showing an error of an angular position at the time when the correcting section 365 is caused to function and the arm 110 is moved. As it is seen from FIG. 6, it is seen that position accuracy of the arm 110 is significantly improved by performing the correction with the correction value determined by the processing explained above.

Note that the servomotor 410 in this embodiment is referred to as “first driving section” as well. The reduction gear 510 is referred to as “first transmitting section” as well. The arm 110 is referred to as “first movable section” as well. The robot control device 300 is referred to as “control device” as well. The motor angle sensor 420 is referred to as “first input-position detecting section” as well. The output-side angle sensor 520 is referred to as “first output-position detecting section” as well. Steps S200 to S400 in FIG. 5 concerning the joint X11 function as “the first processing for deriving parameters for improving position accuracy of the first movable section”.

### B. Second Embodiment

FIG. 7 is an explanatory diagram showing an arm 110a of a robot 100b according to a second embodiment. In the second embodiment, the configuration of the robot 100b is different from the configuration of the robot 100 according to the first embodiment. In the second embodiment, a correction value itself corresponding to an angular position of an input shaft is stored in advance instead of the first correction parameter A and the second correction parameter ϕ, which are the parameters of expression (1) in the first embodiment. In the operation of the robot 100, correction is performed using the correction value. Otherwise, the second embodiment is the same as the first embodiment.

The robot 100b is a six-axis robot including the arm 110a including fix rotary joints J1 to J6. That is, the robot 100b includes the arm 110a configured by six element arms 110b to 110g respectively driven by servomotors in rotary joints via reduction gears. The joints J1, J4, and J6 are torsion joints. The joints J2, J3, and J5 are bending joints. The robot 100b can dispose an end effector attached to the distal end portion of the arm 110a in a designated position in a three-dimensional space in a designated posture by rotating the six joints J1 to J6 respectively with the servomotors. Note that, to facilitate understanding of a technique, in FIG. 7, illustration of the end effector is omitted.

Like the robot 100 according to the first embodiment, the robot 100b includes, concerning the joints, servomotors that drive the joints, reduction gears that reduces rotary outputs of the servomotors, and motor angle sensors that detect angular positions of output shafts of the servomotors (see FIG. 1). Note that the robot 100b does not include, concerning the joints, encoders (the output-side angle sensor 520 shown in FIG. 1) that detect angular positions of output shafts of the reduction gears.

In FIG. 7, to facilitate understanding of a technique, a servomotor 410b, a motor angle sensor 420b, and a reduction gear 510b included in the joint J1 and a servomotor 410c, a motor angle sensor 420c, and a reduction gear 510c included in the joint J3 are shown. A rotation axis of the joint J1 and rotation axes of the joints J2 and J3 are perpendicular to each other.

The robot 100b includes inertial sensors in the element arms 110b to 110g. In FIG. 7, to facilitate understanding of a technique, an inertial sensor 710 included in the element arm 110b between the joints J1 and J2 and an inertial sensor 720 included in the element arm 110d between the joints J3 and J4 are shown.

The inertial sensors 710 and 720 can measure angular velocities around rotation axes in X-axis, Y-axis, and Z-axis directions and output the angular velocities. Measurement values by the inertial sensors 710 and 720 are transmitted to the robot control device 300 and transmitted to the setting device 600 via the robot control device 300.

In the robot system according to the second embodiment, setting of correction parameters is performed according to the processing shown in FIG. 5.

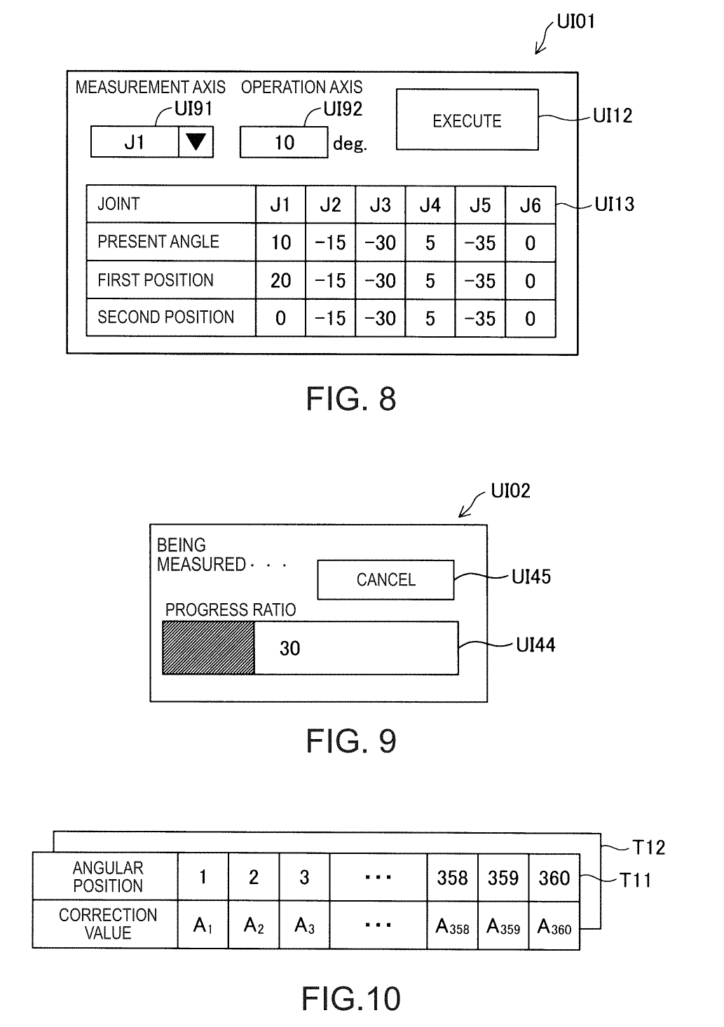

FIG. 8 is a diagram showing a user interface UI01 displayed on the display 602 of the setting device 600 in step S100 in FIG. 5 in the second embodiment. The user interface UI01 includes input windows U191 and U192, a processing start button UI12, and a setting angle display UI13.

The input window U191 is an input window for selecting a joint set as a target of processing for deriving parameters for improving position accuracy. One of the joints J1 to J6 can be selectively input to the input window U191. In FIG. 8, the joint J1 is designated in the input window U191.

The input window U192 is an input window for inputting magnitude of amplitude in a specific operation (i.e., a half of an angular range between a first position and a second position defining both ends of an operation element). A numerical value is input to the input window U191 in advance in default. When a user desires to change the numerical value, the user inputs a numerical value to the input window U192 via the mouse 605 and the keyboard 604. In FIG. 8, “10” is designated in the input window U192.

For the reduction gears of the joints of the robot 100b according to the second embodiment, “10°” is an angular range sufficient for causing a change in a transmission error for one cycle. In the second embodiment, a reduction ratio of the reduction gears of the joints is 1/80. Therefore, the output shaft rotates 2.25° (=180°/80) while the input shaft rotates 180° (rotates a half). Therefore, a rotational motion at the amplitude of 10°, that is, a rotational motion at an angle of 20° between both the ends includes the half rotation of the input shaft for eight times (20°/2.25°). In other words, in an operation element with the amplitude of 10°, a transmission error of the reduction gears causes a change of eight cycles or more.

The setting angle display UI13 is a table for displaying, concerning the joints J1 to J6, an angular position, a first position, and a second position in the present posture of the robot 100b respectively as absolute angular positions.

In an example shown in FIG. 8, the joint J1 is currently present in an angular position of 10° (see UI13). 10° is designated as amplitude at the time when the specific operation (see S200 in FIG. 5) is performed in the joint J1 (see UI92). Therefore, in the joint J1, a first position P11 and a second position P12 are respectively angular positions of 20° ([present position 10°]+[amplitude 10° ]) and 0° ([present position 10°]−[amplitude 10°]) (see UI13). As a result, an angular range between the first position P11 and the second position P12 is 20°. Note that, when the user changes the angular range of the input window U192, the first position and the second position are changed on the basis of the angular range input by the user and the present position.

The amplitude in the specific operation of the respective joints and the first position and the second position are determined to satisfy the following condition. That is, the amplitude and the first position and the second position are decided such that a joint set as a target does not interfere with a structure around the joint even if the joint takes any angular position between the first position and the second position centering on the present position.

In this embodiment, an angular range of the specific operation is determined centering on the present angular position. Therefore, the user can easily determine a specific operation in which the robot 100b does not interfere with a structure around the robot 100b.

In FIG. 7, as a representative example, the first position P11 and the second position P12 of the element arm 110b rotating in the joint J1 and a first position P21 and a second position P22 of the element arm 110d rotating in the joint J3 are schematically shown. In FIG. 7, to facilitate understanding of a technique, the first position P11 and the second position P12 are shown on different arrows respectively indicating a first operation element Me11 and a second operation element Me12. The same applies to the first position P21 and the second position P22 of the element arm 110d rotating in the joint J3.

The processing start button UI12 shown in FIG. 8 is a button for causing the setting device 600, the robot control device 300, and the robot 100b to perform the processing in step S200 and subsequent steps in FIG. 5. When the processing start button UI12 is turned on, the signal SS for instructing processing for deriving parameters for improving position accuracy is generated by the command generating section 612 of the setting device 600 and transmitted from the setting device 600 to the robot control device 300. The signal SS for instructing the processing includes information representing designation of a joint set as a measurement target among the joints J1 to J6.

In this embodiment, the element arms are driven in the joints by the servomotors corresponding to the element arms via the reduction gears. That is, rotation of one joint causes one element arm, the base of which is connected to the joint, to rotationally move. Therefore, the signal SS for instructing the processing for deriving parameters for improving position accuracy substantially includes information representing designation of one element arm set as a measurement target among the plurality of element arms 100b to 110g. Note that, in this specification, the “base” of the element arm is, when viewed along the arm, an end on a side close to a fixed end AB of the entire arm of both ends of the element arm.

In the second embodiment, in step S100 in FIG. 5, the user interface UI01 shown in FIG. 8 is displayed on the display 602 of the setting device 600. The user inputs, via the input window UI91, one of the joints J1 to J6 as a processing target for which parameters for improving position accuracy are derived. The user inputs magnitude of the amplitude of the specific operation via the input window U192. The user presses the processing start button UI12 and causes the setting device 600 to perform the processing in step S200 and subsequent steps in FIG. 5 according to input setting content.

By performing such processing, for example, when the reduction gear of any one of the joints of the robot 100b is replaced, the user can designate the joint driven via the replaced reduction gear (see U191 in FIG. 8). As a result, the user can cause, with simple operation, the setting device 600 to perform the processing for deriving parameters for improving position accuracy of an element arm, one end of which is connected to the joint.

FIG. 9 is a diagram showing a user interface U102 displayed on the display 602 of the setting device 600 when step S200 in FIG. 5 is executed. The user interface U102 includes a progress display UI44 and a cancel button UI45.

The progress display UI44 is a bar graph showing progress of the processing in step S200. As the processing in step S200 advances, the bar graph extends from the left to the right. A progress ratio is indicated by a number at the head of the bar graph. In FIG. 9, the progress ratio is 30%.

The cancel button UI45 is a button for forcibly ending processing performed through the user interface UI01 (see FIG. 8).

In step S200 in FIG. 5, the processing in steps S220 and S240 is repeatedly performed a plurality of times. Therefore, a relatively long time is sometimes taken until completion of the processing. In step S200, by displaying the user interface U102 (see FIG. 9), the user can grasp the progress of the processing. When the user cannot wait for an end of the processing, the user can forcibly end the processing by pressing the cancel button UI45 via the mouse 605. As a result, it is possible to reduce irritation of the user due to the wait for the end of the processing.

In the second embodiment, in step S300 in FIG. 5, the control section 309 calculates, on the basis of the angular velocities around the rotation axes in the X-axis, Y-axis, and Z-axis directions measured during the first operation element, an angular position of the inertial sensor centering on the designated joint during the first operation element. The control section 309 calculates, on the basis of the angular position of the inertial sensor during the first operation element, an angular position of the element arm centering on the designated joint (equal to an angular position of the output shaft of the reduction gear). That is, the inertial sensor does not directly detect the angular position of the element arm but can acquire information equivalent to the angular position of the element arm. Therefore, in a broad sense, an operating position on the output side of the element arm is considered to be detected by the inertial sensor.

The parameter determining section 614 of the setting device 600 calculates first and second correction parameters A and ϕ of the approximation formula (1) on the basis of the angular position of the element arm during the first operation element obtained on the basis of the detection value of the inertial sensor (equal to the angular position of the output shaft of the reduction gear) and a measurement value by the motor angle sensor during the first operation element, which is an angular position of the input shaft of the reduction gear.

In the second embodiment, thereafter, the parameter determining section 614 further sets the first and second correction parameters A1 and ϕ1 in the approximation formula (1) and calculates the angle transmission error α concerning a plurality of angular positions θ of the input shaft of the reduction gear (e.g., 360 angular positions at one-degree intervals). The parameter determining section 614 calculates correction values corresponding to the respective angular positions θ on the basis of the angle transmission error α.

The same processing is performed on the basis of measurement values of the inertial sensor and the motor angle sensor during the second operation element.

FIG. 10 is a diagram showing a correction value table stored in the ROM 302 by the parameter determining section 614 in step S400 in FIG. 5. In step S400, the correction values for cancelling the transmission errors of the reduction gears calculated in step S300 are stored in the ROM 302 as a table in association with the respective angular positions. Two kinds of tables, that is, a table T11 of correction values A₁ to A₃₆₀ associated with directions of the first operation element Me1 and a table T12 of correction values associated with directions of the second operation element Me2 are created and saved in the ROM 302.

In the operation of the robot 100, when the servomotor 410 is rotating in the same direction as the direction of the first operation element Me1, the correcting section 365 of the control section 309 adds, as a correction parameter, a correction value obtained with reference to the table T11 to the position feedback to the position control section 320 (see FIG. 2). More in detail, the correction value is determined by performing complementary processing using two correction values corresponding to closest two angular positions among the angular positions of the input shaft 510i stored in the table T11. The correcting section 365 adds a differential value of the correction value to the speed feedback to the speed control section 330.

When the servomotor 410 is rotating in the same direction as the direction of the second operation element Me2, the correcting section 365 of the control section 309 adds, as a correction parameter, a correction value obtained with reference to the table T12 to the position feedback to the position control section 320 (see FIG. 2). The correcting section 365 adds a differential value of the correction value to the speed feedback to the speed control section 330.

By performing such processing, in the operation of the robot 100, it is possible to perform, with a small load, highly accurate correction of an angle transmission error for cancelling a lost motion and a backlash of the reduction gear compared with a form in which a correction value is calculated on the basis of Expression (1) (see FIGS. 3A to 4B).

Note that the servomotor 410b of the joint J1 in this embodiment is referred to as “first driving section” as well. The reduction gear 510b is referred to as “first transmitting section” as well. The element arm 110b is referred to as “first movable section” as well. The motor angle sensor 420b is referred to as “first input-position detecting section” as well. The inertial sensor 710 of the element arm 110b is referred to as “first output-position detecting section” as well. Steps S200 to S400 in FIG. 5 concerning the joint J1 function as “the first processing for deriving parameters for improving position accuracy of the first movable section”.

The element arms 110b to 110g in this embodiment are referred to as “movable sections” as well. The servomotors that drive the element arms 110b to 110g are referred to as “driving sections” as well. The reduction gears connected to the element arms 110b to 110g are referred to as “transmitting sections” as well.

### C. Third Embodiment

In a third embodiment, a user interface displayed on the display 602 of the setting device 600 in step S100 in FIG. 5 is different from the user interface in the second embodiment. In the third embodiment, a specific operation is simultaneously carried out concerning a plurality of joints, the directions of rotation axes of which are perpendicular to one another. Otherwise, the third embodiment is the same as the second embodiment.

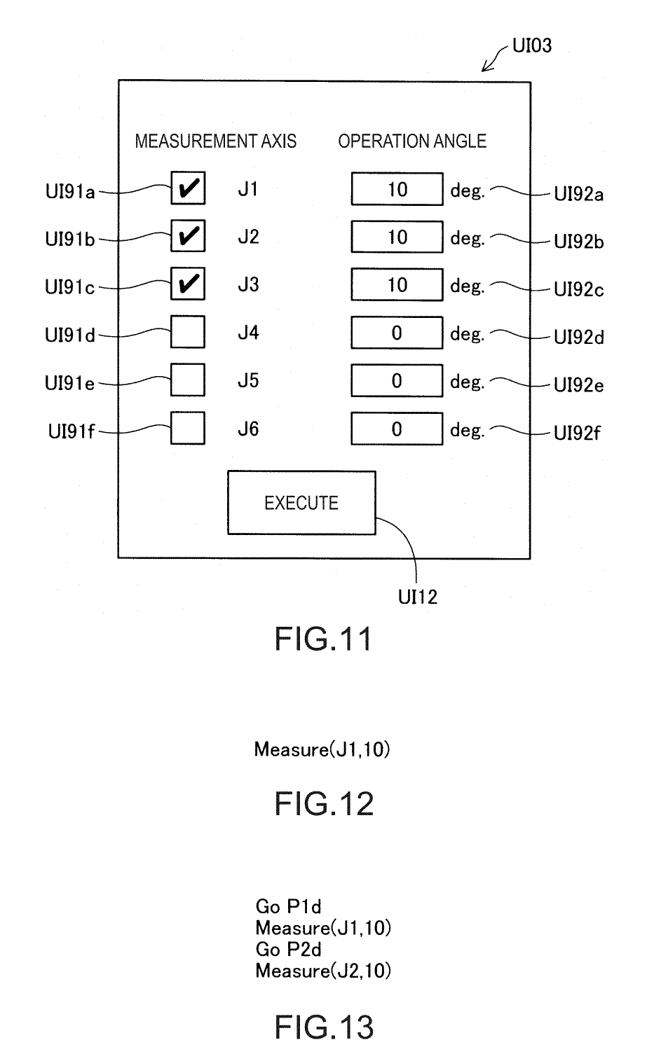

FIG. 11 is a diagram showing a user interface U103 displayed on the display 602 of the setting device 600 in step S100 in FIG. 5 in the third embodiment. The user interface U103 includes input sections UI91a to UI91f, input windows UI92a to UI92f, and the processing start button UI12.

The input sections UI91a to UI91f are checkboxes for selecting one or more joints, which are targets of processing for deriving parameters for improving position accuracy. Designation of one or more of the joints J1 to J6 can be input to the input sections UI91a to UI91f. In an example shown in FIG. 11, the joints J1 to J3 are designated in the input sections UI91a to UI91f.

By performing such processing, a user can easily perform an instruction to the effect that, concerning two or more joints, a specific operation and measurement of operating positions during the specific operation should be performed to detect operating positions on an input side and operating positions on an output side of reduction gears of the joints.

The input windows UI92a to UI92f are input windows for inputting magnitude of amplitude (a half of an angular range between a first position and a second position) in the specific operation. When the user inputs a numerical value of an angular range, the user inputs numerical values to the input windows UI92a to UI92f via the mouse 605 and the keyboard 604. When the user changes an angular range of the input window U192, the first position and the second position are changed on the basis of an angular range input by the user and the present position of a joint (an output shaft of a reduction gear). In FIG. 11, “10°” is designated in the input sections UI91a to UI92c.

A function of the processing start button UI12 is a button for causing the setting device 600, the robot control device 300, and the robot 100b to perform the processing in step S200 and subsequent steps in FIG. 5. When the processing start button UI12 is turned on, the signal SS for instructing processing for deriving parameters for improving position accuracy is generated and transmitted from the setting device 600 to the robot control device 300 (see FIG. 2).

The signal SS for instructing processing for deriving parameters for improving position accuracy is generated by the command generating section 612 of the setting device 600. More specifically, the command generating section 612 performs the following processing. The command generating section 612 selects joints, rotation axes of which are perpendicular to each other, among joints designated via the user interface U103. The command generating section 612 generates the signal SS to the effect that processing should be started, the signal SS including information concerning the joints and information concerning the first position and the second position decided in advance concerning the respective joints.

The signal SS generated in this way is a signal for instructing the following processing. That is, the processing is processing for deriving parameters for improving position accuracy of an element arm connected to one of the designated joints (e.g., the element arm 110b, the base of which is connected to the joint J1) and, in parallel to the processing, deriving parameters for improving position accuracy of an element arm connected to another one of the designated joints (e.g., the element arm 110d, the base of which is connected to the joint J3). The signal SS for instructing such processing includes, as explained above, information representing designation of a joint of one element arm set as a measurement target and designation of a joint of another one element arm set as a measurement target among three or more element arms included in the robot 100b. The signal SS for instructing such parallel processing concerning a plurality of joints is described as “signal SS2” in particular.

Thereafter, the command generating section 612 selects joints, rotation axes of which are perpendicular to each other, from joints not selected yet among the joints designated via the user interface U103. The command generating section 612 generates the signal SS to the effect that processing should be started, the signal SS including information concerning the joints and information concerning the first position and the second position decided in advance concerning the respective joints.

Note that, when a plurality of joints, rotation axes of which are perpendicular to each other, are absent in the joints not selected yet among the joints designated via the user interface UI03, the command generating section 612 selects one joint.

By repeatedly performing such processing, the command generating section 612 generates, concerning all the joints designated via the user interface U103, the signals SS to the effect that the processing for deriving parameters for improving position accuracy should be started. The signals are sequentially transmitted from the setting device 600 and received by the receiving section 307 of the robot control device 300.

Processing performed when the receiving section 307 receives the signal SS for instructing the processing for deriving parameters for improving position accuracy of one element arm is the same as the processing explained in the second embodiment.

When the receiving section 307 receives the signal SS2 for instructing the processing for deriving parameters for improving position accuracy of a plurality of element arms, the control section 309 of the robot control device 300 performs the following processing in step S200 in FIG. 5 because of the reception of the signal SS2.

That is, the control section 309 controls the servomotor of the robot 100b and causes an element arm connected to one of the designated joints to perform a specific operation (hereinafter referred to as “first specific operation” as well) and causes an element arm connected to another one of the designated joints to perform a specific operation (hereinafter referred to as “second specific operation” as well) in parallel to the first specific operation. The control section 309 controls the servomotor 410b operating in the joint J1 and causes the element arm 110b to perform the first specific operation. The control section 309 controls the servomotor 410b operating in the joint J3 and causes the element arm 110d to perform the second specific operation.

Content of the specific operation is as explained in the first embodiment. Note that a rotation axis of the first specific operation in the joint J1 and a rotation axis of the second specific operation in the joint J3 are perpendicular to each other. In the first specific operation in the joint J1, the amplitude of the first operation element Me11 and the second operation element Me12 is 10° (see FIG. 11). In the second specific operation in the joint J3, the amplitude of a first operation element Me21 and a second operation element Me22 is 10° (see FIG. 11).

When the receiving section 307 receives the signal SS2 for instructing the processing for deriving parameters for improving position accuracy of a plurality of element arms, as explained above, the specific operation is simultaneously executed concerning the plurality of joints. Operating positions on the input side of reduction gears of the joints and operating positions on the output side of the reduction gears are measured concerning a forward movement and a backward movement.

By performing such processing, it is possible to determine, in a short time, parameters for improving position accuracy of the element arms connected to the joints compared with a form in which measurement concerning the reduction gears of the joints is performed one after another.

In this embodiment, the rotation axes of the joints, on which the specific operation and the measurement of errors are performed in parallel, are perpendicular to each other. Therefore, it is possible to obtain accurate measurement results by the first specific operation and the second specific operation without the first specific operation and the second specific operation affecting the measurement results each other.

In this embodiment, the specific operation is automatically executed concerning a plurality of joints designated in advance. Therefore, to cause the robot system 1 to perform the specific operation and perform measurement concerning the plurality of joints, the user does not need to give an execution instruction (UI12 in FIG. 11) to the robot system 1 a plurality of times.

Note that the servomotor 410b of the joint J1 in this embodiment is referred to as “first driving section” as well. The reduction gear 510b is referred to as “first transmitting section” as well. The element arm 110b is referred to as “first movable section” as well. The motor angle sensor 420b is referred to as “first input-position detecting section” as well. The inertial sensor 710 of the element arm 110b is referred to as “first output-position detecting section” as well. Steps S200 to S400 in FIG. 5 concerning the joint J1 function as “the first processing for deriving parameters for improving position accuracy of the first movable section”.

Note that the servomotor 410c of the joint J3 in this embodiment is referred to as “second driving section” as well. The reduction gear 510c is referred to as “second transmitting section” as well. The element arm 110d is referred to as “second movable section” as well. The motor angle sensor 420c is referred to as “second input-position detecting section” as well. The inertial sensor 720 of the element arm 110d is referred to as “second output-position detecting section” as well. Steps S200 to S400 in FIG. 5 concerning the joint J3 function as “the second processing for deriving parameters for improving position accuracy of the second movable section”.

The first position P21 of the element arm 110d rotating in the joint J3 is referred to as “third position” as well to be distinguished from the first position of the element arm 110b driven simultaneously with the element arm 110d. The second position P22 of the element arm 110d is referred to as “fourth position” as well to be distinguished from the second position of the element arm 110b driven simultaneously with the element arm 110d.

Concerning the joint J3, the first operation element Me21 that moves the element arm 110d from the first position P21 to the second position P22 is referred to as “third operation element” as well to be distinguished from the first operation element of the element arm 110b driven simultaneously with the element arm 110d. Concerning the joint J3, the second operation element Me22 that moves the element arm 110d from the second position P22 to the first position P21 is referred to as “fourth operation element” as well to be distinguished from the second operation element of the element arm 110b driven simultaneously with the element arm 110d.

### D. Fourth Embodiment

In the embodiments explained above, the user performs an input via the display 602 of the setting device 600. The command generating section 612 generates a command to the robot control device 300 according to the input. However, the user can directly input a command and cause the control section 309 of the robot control device 300 to perform a specific operation. A fourth embodiment is different from the second embodiment in a method of generating the signal SS for instructing the processing for deriving parameters for improving position accuracy of an element arm. Otherwise, the fourth embodiment is the same as the second embodiment.

FIG. 12 is a diagram showing a command and attached parameters for causing the joint J1 to perform the specific operation in an angular range of 10° in step S200 in FIG. 5. Implementation of the specific operation (see S200 in FIG. 5) is instructed by a command “Measure”. A joint moved in the specific operation is designated by a first parameter “J1” behind the command “Measure”. The joint “J1” is designated (see FIG. 7). Amplitude at the time when the joint is moved in the specific operation is designated by a second parameter “10” behind the command “Measure”. “10°” is designated (see U192 in FIG. 8). Note that an example of the command and the parameters shown in FIG. 12 designates the same content as the example of the user interface U101 shown in FIG. 8 (see U191 and U192 in FIG. 8).

Such a command is input to the setting device 600 via the keyboard 604. The command generating section 612 of the setting device 600 creates, on the basis of the input command, the signal SS to the effect that the processing in step S200 and subsequent steps in FIG. 5 should be started and transmits the signal SS to the robot control device 300. The receiving section 307 of the robot control device 300 receives the signal SS representing a command to the effect that the processing for deriving parameters should be started.

With such a form, the user can designate processing content desired by the user in detail using the command and cause the robot control device 300 to detect an operating position on an input side and an operating position on an output side of a reduction gear of a joint.

FIG. 13 is a diagram showing a plurality of commands and a plurality of attached parameters for causing the joints J1 and J2 to respectively perform the specific operations in the angular range of 10° in step S200 in FIG. 5. The robot 100b is instructed to take a specific posture by a command “Go”. The specific posture is designated by a parameter “P1d” behind the command “Go”. After the robot 100b takes the posture specified by the parameter “P1d”, the specific operation is executed at the amplitude of 10° concerning the joint J1 according to a command “Measure (J1, 10)” centering on an angular position of the joint J1 at that time.

Thereafter, similarly, after the robot 100b takes a posture specified by a parameter “P2d” according to a command “Go P2d”, the specific operation is executed at the amplitude of 10° concerning the joint J2 according to a command “Measure (J2, 10)” centering on an angular position of the joint J2 at that time.

The plurality of commends shown in FIG. 13 are also input to the setting device 600 via the keyboard 604. The command generating section 612, which is a functional section of the CPU 610 of the setting device 600, creates the signal SS on the basis of the input plurality of commands and transmits the signal SS to the robot control device 300. The receiving section 307 of the robot control device 300 receives the signal SS representing a command to the effect that the processing for deriving parameters should be started.

With such a form, the user can cause, concerning designated joints, the robot control device 300 to detect operating positions on an input side and operating positions on an output side of reduction gears of the joints in order desired by the user.

For example, in the specific posture designated by the parameter “P1d”, even if the joint J1 is moved at the amplitude of 10°, the robot 100b does not interfere with other devices. However, in the specific posture designated by the parameter “P1d”, when the joint J2 is moved at the amplitude of 10°, the robot 100b sometimes interferes with other devices. According to this embodiment, the user can change, using a command, concerning the respective joints, with the specific operations, the posture of the robot to an operating position where the robot does not interfere with other devise and cause the joints to perform the specific operations.

### E. Other Embodiments

### E1. Another Embodiment 1

(1) In the first embodiment, the input shaft 510i of the reduction gear 510 is connected to the output shaft 410o of the servomotor 410. The angular position of the output shaft 410o of the servomotor 410 and the angular position of the input shaft 510i of the reduction gear 510 are equal (see 410o and 510i in FIG. 1). However, a mechanism that changes a rotational speed such as another gear mechanism or a belt and a pulley may be provided between the driving section that generates a driving force and the transmitting section. When a reduction ratio of such a mechanism is represented as Np and an angular position of the output shaft of the driving section is represented as θo, the angular position θ of the input shaft of the reduction gear is obtained by θ=Np×θo.

(2) In the first embodiment, the motor angle sensor 420 functioning as the first input-position detecting section detects an angular position of the output shaft 410o of the servomotor 410 functioning as the first driving section (see FIG. 1). However, the first input-position detecting section that detects an operating position on the input side of the first transmitting section may measure an input of the first transmitting section.

(3) In the first embodiment, the robot control device 300 is provided as a component separate from the robot 100 (see FIG. 1). However, the control device can be provided integrally with the robot. The control device can be provided separately from the robot and connected to the robot by wire or radio.

In the first embodiment, the setting device 600 is provided as a component separate from the robot control device 300 and the robot 100 (see FIG. 1). However, the setting device can be provided integrally with the control device and/or the robot. The setting device can be provided separately from the control device and connected to the control device by wire or radio.

Another device may include a part of the functional sections of the robot control device 300 or the setting device 600. For example, the robot control device 300 may include a part or all of the functions of the parameter determining section 614 and the like included in the setting device 600 in the first embodiment.

In the embodiments, apart of the components realized by hardware may be replaced with software. Conversely, a part of the components realized by software may be replaced with hardware. For example, in the embodiments, the CPU functioning as the control section 309 realizes the various functions by reading out and executing the computer programs. However, apart or all of the functions realized by the control section may be realized by hardware circuits. The control section can be configured as a processor that realizes some processing.

### E2. Another Embodiment 2

In the first embodiment, the first operation element Me1 and the second operation element Me2 are the rotations (see FIG. 1). However, the first operation element Me1 and the second operation element Me2 may be linear movements. In the first embodiment, the first position P1 and the second position P2 are the angular positions. However, the first position and the second position may be positions on a straight line.

The driving section can be, for example, a motor, an output of which is a rotational motion. The driving section may be a linear motor or a cylinder, an output of which is a linear operation.

### E3. Another Embodiment 3

In the first embodiment, both of the moving speeds of the first operation element Me1 and the second operation element Me2 are 100°/second or less. However, the moving speeds of the first operation element and the second operation element may be moving speeds larger than 100°/second such as 150°/second or 300°/second.

### E4. Another Embodiment 4

In the first embodiment, the angular range defined by the first position and the second position is the angular range in which the reduction gear 510 causes a change in a transmission error for one cycle or more and does not cause a change in a transmission error for four cycles or more. In the second embodiment, the angular range defined by the first position and the second position is an angular range in which a transmission error of the reduction gear causes a change for eight cycles or more.

However, the angular range defined by the first position and the second position can be set to another angular range. For example, the angular range defined by the first position and the second position can be set to an angular range (e.g., an angular range including a half cycle) shorter than an angular range in which a transmission error for one cycle is caused. In such a form as well, it is possible to estimate a transmission error for one cycle on the basis of an obtained measurement value.

### E5. Another Embodiment 5

In the first embodiment, the transmitting section that transmits a driving force is the reduction gear 510. However, the transmitting section for which a transmission error is reduced may be configured to convert a rotary input to a rotary output having higher rotational speed. The rotary input and the rotary output may substantially coincide with each other.

More specifically, the transmitting section can be a belt and a pulley, a gear mechanism, or a joint. The belt and the pulley and the gear mechanism may be configured to convert a rotary input into a rotary output having higher rotational speed or may be configured to convert a rotary input into a rotary output having lower rotational speed. The rotary input and the rotary output may substantially coincide with each other.

### E6. Another Embodiment 6

In the first embodiment, the output-side angle sensor 520 detects an angular position of the output shaft 510o of the reduction gear 510 functioning as the first transmitting section. However, the first output-position detecting section that detects an operating position on the output side of the first transmitting section may measure an output of the first transmitting section or may measure an operating position of a downward component driven by the output of the first transmitting section. As components that measure the operating position of the downstream component driven by the output of the first transmitting section, there are, for example, the inertial sensors 710 and 720 in the second embodiment. For example, it is also possible to fix the joint J3 and perform the specific operation concerning the joint J2, obtain a measurement value using the inertial sensor 720 included in the element arm 110d further downstream of the element arm 110c connected to the joint J2, and determine a correction value of the joint J2.

The influence of an error of an operating position of a joint close to the fixed end (see AB in FIG. 7) of the entire arm on the position of the end effector at the distal end of the arm is large compared with the influence of an error of an operating position of a joint far from the fixed end AB (i.e., close to the distal end of the arm) on the position of the end effector. This is because, concerning the joint close to the fixed end of the entire arm, the distance from a rotation axis of the joint to the distal end of the arm is long. Therefore, among all the joints included in the robot, only a part of the joints close to the fixed end of the entire arm may include an inertial sensor for measuring an error of an operating position and correcting the error. For example, in the robot 100b according to the second embodiment, in the form in which only the joints J1 to J3 among the joint J1 to J6 are corrected, the robot 100b according to the second embodiment may include only the inertial sensors 710 and 720 provided in the element arms 110b and 110d among the inertial sensors provided in the element arms 110b to 110g.

### E7. Another Embodiment 7

In the second embodiment, gyro sensors are used as the inertial sensors (see 710 and 720 in FIG. 7). However, as an output-position detecting section that detects an operating position on the output side of the transmitting section, other various sensors can be used. For example, as the output-position detecting section, an IMU (Inertial Measurement Unit) that can detect accelerations and angular velocities in the X-axis, Y-axis, and Z-axis directions can be adopted. As the output-position detecting section, an acceleration sensor that can detect accelerations in one or more directions among the X-axis, Y-axis, and Z-axis directions can be adopted. Further, as the output-position detecting section, an inertial sensor that can detect accelerations in one or more directions among the X-axis, Y-axis, and Z-axis directions and angular velocities in one or more directions among the X-axis, Y-axis, and Z-axis directions can be adopted. That is, the first output-position detecting section can be an inertial sensor that can detect at least the angular velocity and the acceleration of the first movable section. As the output-position detecting section, a laser displacement gauge, a camera, or the like that can detect an operating position on the output side of the transmitting section can be adopted. The sensor attached to the measurement target during the measurement may be a sensor incorporated in a device in advance or may be a sensor attached to the device for the measurement.

### E8. Another Embodiment 8

In the second embodiment, correction values are calculated concerning the 360 angular positions at one-degree intervals and stored as the tables T11 and T12 (see FIG. 10). However, correction values stored in advance may correspond to other operating positions on the input side. The correction values stored in advance may be correction values corresponding to a plurality of operating positions that are not at equal intervals from one another.

### E9. Another Embodiment 9

In the first embodiment, the correction parameters A and ϕ included in Expression (1) for determining a correction value are stored in advance. However, parameters stored in advance may be coefficients of another expression for determining a correction value or may be parameters for appropriately selecting a correction value group prepared in advance.

### E10. Another Embodiment 10

In the first embodiment, the first operation element is the operation for moving the arm 110 from the first position P1 to the second position P2. The second operation element is the operation for moving the arm 110 from the second position P2 to the first position P1. Therefore, operation sections of the first operation element and the second operation element are equal. However, the first operation element and the second operation element can be operations executed in different operation sections. The operation sections of the first operation element and the second operation element may be partially overlapping operation sections. For example, at least one of angular ranges and phases of the first operation element and the second operation element may be different.

### E11. Another Embodiment 11

(1) In the embodiments, the plurality of sets of measurement values are used in the multiple regression analysis performed to determine Expression (1). However, the plurality of sets of measurement values can be used in determination of a correction value in other methods. For example, an average can be calculated from the plurality of sets of measurement values obtained by the specific operation. A coefficient of an expression for determining a correction value can be determined on the basis of the average.

(2) In the embodiments, the processing in steps S220 and S240 in FIG. 5 is performed a plurality of times. However, the processing for measuring an operating position on the input side and an operating position on the output side of the transmitting section can be performed only once.

### E12. Another Embodiment 12

In the fourth embodiment, the command for instructing the specific operation concerning one joint is explained (see FIGS. 12 and 13). However, a command for instructing execution of specific operations concerning a plurality of joints in at least partially overlapping time sections can be adopted.

### E13. Another Embodiment 13

In the second embodiment, the present disclosure is explained with reference to the six-axis robot as an example. However, the present disclosure can also be applied to a four-axis robot and robots including other numbers of joints. However, the present disclosure is desirably applied to a device including two or more joints and more desirably applied to a device including three or more joints.

### E14. Another Embodiment 14

(1) In the second embodiment, the measurement processing concerning the joint J1 and the measurement processing concerning the joint J3 having the rotation axis perpendicular to the joint J1 are performed in parallel. However, measurement concerning a plurality of joints can be executed in partially or entirely different time sections. However, measurement concerning different joints is desirably performed in at least partially overlapping time sections.

(2) Joints for which measurement of transmission errors is performed in parallel do not have to be joints, motion axes of which are perpendicular to each other. For example, concerning a plurality of joints, motion axes of which are present in positions twisted from one another, measurement of transmission errors can be performed in at least partially overlapping time sections. Even in a plurality of joints, motion axes of which are parallel to one another, concerning joints assumed to be always moved in synchronization during operation, measurement of transmission errors can be performed in at least partially overlapping time sections.

### E15. Another Embodiment 15

In the second embodiment, the measurement processing concerning the torsion joint J1 and the measurement processing concerning the torsion joint J3 are performed in parallel. However, joints for which measurement of transmission errors is performed in parallel are not limited to rotary joints and may be rectilinear joints.

### E16. Another Embodiment 16

In the third embodiment, the command generating section 612 of the setting device 600 determines, according to an input from the user, the joint for which measurement of transmission errors is simultaneously performed (see FIG. 11). However, a form can also be adopted in which combinations of joints for which measurement of transmission errors is simultaneously performed are decided in advance and stored in a storing section such as a ROM and the user selects, through a user interface, one or more combinations out of the combinations of joints stored in advance.

### E17. Another Embodiment 17

(1) In the embodiments, the present disclosure is explained with reference to the robot as an example. However, the technique disclosed in this specification is not limited to the robot and can be applied to various machines, physical states of which change according to control performed via transmitting sections that transmit driving forces, such as a printer and a projector. For example, by applying the technique disclosed in this specification to an operation of a printing head of a printer and a conveying operation for a printing medium, it is possible to improve accuracy of relative positions of the printing head and the printing medium.

(2) The present disclosure is not limited to the embodiments and can be realized in various configurations without departing from the spirit of the present disclosure. For example, the technical features in the embodiments corresponding to the technical features in the aspects described in the summary can be replaced or combined as appropriate in order to solve a part or all of the problems described above or achieve a part or all of the effects described above. Unless the technical features are explained as essential technical features in this specification, the technical features can be deleted as appropriate.

The entire disclosure of Japanese Patent Application No. 2017-118375, filed Jun. 16, 2017 is expressly incorporated by reference herein.

What is claimed is:

1. A control device comprising:
a processor that is configured to execute computer-executable instructions so as to control a robot including a first arm driven via a first reduction gear by a first motor configured to generate a driving force,
wherein the processor is configured to:
receive a signal for instructing first processing for deriving parameters for improving position accuracy of the first arm; and
control the first motor and cause the first arm to perform a first specific operation, wherein
the first specific operation includes a first operation element for moving the first arm from a first position to a second position and a second operation element for moving the first arm in an opposite direction of a direction of the first operation element, and
when the first operation element and the second operation element are executed, the processor is configured to:
detect, using a first input-position sensor configured to detect an operating position on an input side of the first reduction gear, the operating position on the input side of the first reduction gear and
detect, using a first output-position sensor configured to detect an operating position on an output side of the first reduction gear, the operating position on the output side of the first reduction gear.

2. The control device according to claim 1, wherein
the first operation element and the second operation element are rotations,
the operating position on the input side of the first reduction gear is an angular position, and
the operating position on the output side of the first reduction gear is an angular position.

3. The control device according to claim 2, wherein both of moving speeds of the first operation element and the second operation element are 100°/second or less.

4. The control device according to claim 2, wherein
the first reduction gear causes a cyclic transmission error with respect to a continuous constant input from the first motor, and
an angular range between the first position and the second position includes an angular range in which the transmission error for one cycle is caused.

5. The control device according to claim 2, wherein the first output-position sensor can detect an operating position of an output shaft of the first reduction gear.

6. The control device according to claim 1, wherein the first output-position sensor is an inertial sensor that can detect at least one of angular velocity and acceleration of the first arm.

7. The control device according to claim 1, wherein the parameters include a correction value for reducing a transmission error of the first reduction gear.

8. The control device according to claim 1, wherein the parameters include a parameter for deriving a correction value for reducing a transmission error of the first reduction gear.

9. The control device according to claim 1, wherein the second operation element is an operation for moving the first arm from the second position to the first position.

10. The control device according to claim 9, wherein the first specific operation includes a plurality of combinations of the first operation element and the second operation element.

11. The control device according to claim 1, wherein the processor is configured to receive, as the signal for instructing the first processing, a signal representing a command to the effect that the first processing should be executed.

12. The control device according to claim 1, wherein
the robot includes two or more arms driven in joints via reduction gears by motors configured to respectively generate driving forces, and
the signal for instructing the first processing includes information representing designation of the joint of one arm functioning as the first arm among the two or more arms.

13. The control device according to claim 1, wherein
the robot includes a second arm driven via a second reduction gear by a second motor configured to generate a driving force,
the processor is configured to receive a signal for instructing second processing for deriving the parameters for improving position accuracy of the first arm and deriving parameters for improving position accuracy of the second arm, and control the first motor and causes the first arm to perform the first specific operation and controls the second motor and causes the second arm to perform a second specific operation in parallel to at least apart of the first specific operation,
the second specific operation includes a third operation element for moving the second arm from a third position to a fourth position and a fourth operation element for moving the second arm in an opposite direction of a direction of the third operation element, and
the processor is configured to detect the operating position on the input side of the first reduction gear using the first input-position sensor and detect the operating position on the output side of the first reduction gear using the first output-position sensor when the first operation element and the second operation element are executed and detect, using a second input-position sensor configured to detect an operating position on the input side of the second reduction gear, the operating position on the input side of the second reduction gear and detect, using a second output-position sensor configured to detect an operating position on the output side of the second reduction gear, the operating position on the output side of the second reduction gear when the third operation element and the fourth operation element are executed.

14. The control device according to claim 13, wherein
the first operation element to the fourth operation element are rotations,
all of the operating position on the input side of the first reduction gear, the operating position on the output side of the first reduction gear, the operating position on the input side of the second reduction gear, and the operating position on the output side of the second reduction gear are angular positions, and
a rotation axis of the first arm and a rotation axis of the second arm are perpendicular to each other.

15. The control device according to claim 13, wherein
the robot includes three or more arms driven in joints via reduction gears by motors configured to generate driving forces, and
the signal for instructing the second processing includes information representing designation of the joint of one arm functioning as the first arm and designation of the joint of another one arm functioning as the second arm among the three or more arms.

16. A robot system comprising:
a robot including a first arm driven via a first reduction gear by a first motor configured to generate a driving force; and
a control device comprising a processor that is configured to execute computer-executable instructions so as to control the robot,
wherein the processor is configured to:
receive a signal for instructing first processing for deriving parameters for improving position accuracy of the first arm; and
control the first motor and cause the first arm to perform a first specific operation, wherein
the first specific operation includes a first operation element for moving the first arm from a first position to a second position and a second operation element for moving the first arm in an opposite direction of a direction of the first operation element, and
when the first operation element and the second operation element are executed, the processor is configured to:
detect, using a first input-position sensor configured to detect an operating position on an input side of the first reduction gear, the operating position on the input side of the first reduction gear and
detect, using a first output-position sensor configured to detect an operating position on an output side of the first reduction gear, the operating position on the output side of the first reduction gear.

17. The robot system according to claim 16, wherein
the first operation element and the second operation element are rotations,
the operating position on the input side of the first reduction gear is an angular position, and
the operating position on the output side of the first reduction gear is an angular position.

18. The robot system according to claim 17, wherein both of moving speeds of the first operation element and the second operation element are 100°/second or less.

19. The robot system according to claim 17, wherein
the first reduction gear causes a cyclic transmission error with respect to a continuous constant input from the first motor, and
an angular range between the first position and the second position includes an angular range in which the transmission error for one cycle is caused.

20. The robot system according to claim 17, wherein the first output-position sensor can detect an operating position of an output shaft of the first reduction gear.
